(19) United States
(12) Patent Application Publication
(10) Pub. No.: US 2025/0045705 A1
(43) Pub. Date: Feb. 6, 2025

(54) SERVICE INFORMATION PROCESSING METHOD AND APPARATUS AND ELECTRONIC DEVICE

(71) Applicant: Beijing Zitiao Network Technology Co., Ltd., Beijing (CN)

(72) Inventors: Weilun GUO, Beijing (CN); Bo LI, Beijing (CN); Zhendong JIANG, Beijing (CN)

(21) Appl. No.: 18/922,027

(22) Filed: Oct. 21, 2024

Related U.S. Application Data
(63) Continuation of application No. PCT/CN2023/089792, filed on Apr. 21, 2023.

(30) Foreign Application Priority Data
Apr. 21, 2022 (CN) 202210426221.X

(51) Int. Cl. G06Q 10/1093; G06F 21/62; G06F 40/18; G06Q 10/1053

(52) U.S. Cl. CPC G06Q 10/1093; G06F 21/6209; G06F 40/18; G06Q 10/1053

(57) ABSTRACT

An event management application is configured with a plurality of spreadsheet component sets, each configured on the basis of each service stage in the service process of a target event, and used for at least one of: storing service information in the service process and displaying; or, changing the stored service information on the basis of the configuration in the event management application in response to input of a user. The event management application is configured with permission information in respect of the event management application of participants in each service stage; or, the event management application is configured with linkage settings for data in the plurality of spreadsheets corresponding to the plurality of spreadsheet components in each spreadsheet component set. The permission information and the linkage settings are determined on the basis of the service information of the corresponding service stage.

### CROSS-REFERENCING OF RELEVANT APPLICATIONS

The present application is based on and claims the priority to the PCT application No. PCT/CN2023/089792 filed on Apr. 21, 2023 and the Chinese patent application No. 202210426221.X filed on Apr. 21, 2022, entitled “Service Information Processing Method and Apparatus and Electronic Device”. The entire contents of these applications are hereby incorporated by reference into the present application.

### TECHNICAL FIELD

The present disclosure relates to the technical field of the Internet, and in particular, to a service information processing method and apparatus, and an electronic device.

### BACKGROUND

Companies or individuals often have complex matters to deal with, such as the need of companies to recruit. To deal with these complex matters, professional processing software is currently used to deal with the flows of these complex matters in a unified way, or different personnel use different files to record relevant information respectively, and then the progress of the project is promoted through offline interaction between personnel, etc.

### SUMMARY

In order to solve the above technical problems or at least partially solve the above technical problems, the present disclosure provides a service information processing method and apparatus, and an electronic device, and thus flexible management of service information of events can be achieved.

In order to achieve the above objective, the technical solutions provided in the embodiments of the present disclosure are as follows:

In a first aspect, provided is a service information processing method, including that:
an event management application is configured with a plurality of spreadsheet component sets, and each spreadsheet component set in the plurality of spreadsheet component sets is configured based on each service stage in the service flow of a target event, and is configured to do at least one of: store service information in the service flow and display; or, change the stored service information based on a configuration in the event management application in response to input from a user;
wherein the method further comprises at least one of:
the event management application is configured with permission information in respect of the event management application of participants in each service stage;
or,
the event management application is configured with linkage settings for data in a plurality of spreadsheets corresponding to a plurality of spreadsheet components in each spreadsheet component set, where the permission information and the linkage settings are determined based on the service information of a corresponding service stage.

As an optional implementation of the embodiments of the present disclosure, the permission information includes at least one of the following:
an access permission to the event management application;
a permission to display each spreadsheet component set;
a permission to display each spreadsheet component in each spreadsheet component set; and
a permission to display the data in a spreadsheet corresponding to each spreadsheet component.

As an optional implementation of the embodiments of the present disclosure, the method also includes:
acquiring identity information of the user logging into the event management application; and
displaying a page of the event management application according to a permission range corresponding to the identity information.

As an optional implementation of the embodiments of the present disclosure, the page of the event management application includes: a spreadsheet selection area and a spreadsheet display area;
the spreadsheet selection area includes at least one spreadsheet component set among the plurality of spreadsheet component sets, and each spreadsheet component set includes at least one spreadsheet component; the spreadsheet display area displays a target spreadsheet corresponding to a currently selected target spreadsheet component.

As an optional implementation of the embodiments of the present disclosure, the method also includes:
in response to a first record information being entered into the target spreadsheet, outputting a prompt message in response to a field value of a first field in the first record information being repeated with a field value of a second field in other record information, the prompt message being used to prompt that the field value of the first field is repeated with the field value of the second field.

As an optional implementation of the embodiments of the present disclosure, the outputting a prompt message in response to a field value of a first field in the first record information being repeated with a field value of a second field in other record information includes:
in response to the field value of the first field in the first record information being repeated with the field value of the second field in other record information, filling a prompt field value in a repeat prompt field in the target spreadsheet, the prompt field value being used to prompt that the field value of the first field is repeated with the field value of the second field.

As an optional implementation of the embodiments of the present disclosure, after configuring linkage settings for data in a plurality of spreadsheets corresponding to a plurality of spreadsheet components in each spreadsheet component set, the method also comprises:
in response to an editing operation on a first service information corresponding to a first field, updating the first service information to a second service information; and
updating a third service information corresponding to a second field to a fourth service information according to the second service information;
where the first field and the second field are different fields in the plurality of spreadsheets.

As an optional implementation of the embodiments of the present disclosure, the first field and the second field are different fields in a same spreadsheet among the plurality of spreadsheets,
alternatively,
the first field and the second field are fields in different spreadsheets among the plurality of spreadsheets, and different spreadsheet components corresponding to the different spreadsheets belong to a same spreadsheet component set; the service information corresponding to the first field and the service information corresponding to the second field are service information in a same service stage;
alternatively,
the first field and the second field are fields in different spreadsheets among the plurality of spreadsheets, and different spreadsheet components corresponding to the different spreadsheets belong to different spreadsheet component sets; the service information corresponding to the first field and the service information corresponding to the second field are service information in different service stages.

As an optional implementation of the embodiments of the present disclosure, the target event includes a recruitment event;
the service information corresponding to the first field includes any of the following information:
interview progress information and candidate information;
the service information corresponding to the second field includes any of the following information:
the interview progress information, the candidate information, degree of completion of recruitment requirements, and record information of new employees.

As an optional implementation of the embodiments of the present disclosure, the method also includes:
in response to a preset trigger, extracting target service information from a first spreadsheet, the first spreadsheet being at least one spreadsheet in the event management application; and
synchronizing the target service information to a target application.

As an optional implementation of the embodiments of the present disclosure, the synchronizing the target service information to a target application includes:
determining a first parameter of a first type of information in the target application based on the target service information, and synchronizing the first parameter to the target application, so as to instruct the target application to display the first type of information according to the first parameter.

As an optional implementation of the embodiments of the present disclosure, the target application is a calendar application, and the synchronizing the target service information to a target application includes:
based on the target service information, creating or updating a first schedule information corresponding to the target service information by means of a target calendar in the target application.

As an optional implementation of the embodiments of the present disclosure, the target calendar includes a calendar associated with the event management application in the calendar application.

As an optional implementation of the embodiments of the present disclosure, the based on the target service information, creating or updating a first schedule information corresponding to the target service information by means of a target calendar in the target application includes:
based on the target service information, creating or updating a first schedule information corresponding to the target service information in the target calendar;
determining participant information corresponding to the first schedule information; and
creating or updating the first schedule information in personal calendars associated with the participant information.

As an optional implementation of the embodiments of the present disclosure, the based on the target service information, creating or updating a first schedule information corresponding to the target service information by means of a target calendar in the target application includes:
determining participant information corresponding to the target service information, the target calendar including personal calendars in the calendar application associated with the participant information; and
based on the target service information, creating or updating the first schedule information in the personal calendars.

In a second aspect, provided is a service information processing apparatus, including:
a spreadsheet component module, which includes a plurality of spreadsheet component sets for the service information processing apparatus, each spreadsheet component set in the plurality of spreadsheet component sets being configured based on each service stage in a service flow of a target event, and being configured to store service information in the service flow and display and/or change the stored service information based on a configuration of the service information processing apparatus in response to input from a user; and
a configuration module, configured to configure permission information in respect of the service information processing apparatus of participants in each service stage for the service information processing apparatus, and/or configure linkage settings for data in a plurality of spreadsheets corresponding to a plurality of spreadsheet components in each spreadsheet component set, wherein the permission information and the linkage settings are determined based on the service information of a corresponding service stage.

As an optional implementation of the embodiments of the present disclosure, the permission information includes at least one of the following:
an access permission to the service information processing apparatus;
a permission to display each spreadsheet component set;
a permission to display each spreadsheet component in each spreadsheet component set; and
a permission to display the data in a spreadsheet corresponding to each spreadsheet component.

As an optional implementation of the embodiments of the present disclosure, the apparatus also includes:
an acquisition module, used for acquiring identity information of a user logging into the service information processing apparatus; and
a display module, used for displaying a page of the service information processing apparatus according to a permission range corresponding to the identity information.

As an optional implementation of the embodiments of the present disclosure, the page of the service information processing apparatus includes: a spreadsheet selection area and a spreadsheet display area;
the spreadsheet selection area includes at least one spreadsheet component set among the plurality of spreadsheet component sets, and each spreadsheet component set includes at least one spreadsheet component; the spreadsheet display area displays a target spreadsheet corresponding to a currently selected target spreadsheet component.

As an optional implementation of the embodiments of the present disclosure, the apparatus also includes: a prompt output module of the service information processing apparatus, used for, in response to a first record information being entered into the target spreadsheet, outputting a prompt message in response to a field value of a first field in the first record information being repeated with a field value of a second field in other record information, the prompt message being used to prompt that the field value of the first field is repeated with the field value of the second field.

As an optional implementation of the embodiments of the present disclosure, the prompt output module is specifically used for: in response to the field value of the first field in the first record information being repeated with the field value of the second field in other record information, filling a prompt field value in a repeat prompt field in the target spreadsheet, the prompt field value being used to prompt that the field value of the first field is repeated with the field value of the second field.

As an optional implementation of the embodiments of the present disclosure, the service information processing apparatus is configured with linkage settings for data in a plurality of spreadsheets corresponding to a plurality of spreadsheet components in each spreadsheet component set, and the apparatus also includes:
an update module, used for, in response to an editing operation on a first service information corresponding to a first field, updating the first service information to a second service information; and
updating a third service information corresponding to a second field to a fourth service information according to the second service information;
where the first field and the second field are different fields in the plurality of spreadsheets.

As an optional implementation of the embodiments of the present disclosure, the first field and the second field are different fields in a same spreadsheet among the plurality of spreadsheets,
alternatively,
the first field and the second field are fields in different spreadsheets among the plurality of spreadsheets, and different spreadsheet components corresponding to the different spreadsheets belong to a same spreadsheet component set; the service information corresponding to the first field and the service information corresponding to the second field are service information in a same service stage;
alternatively,
the first field and the second field are fields in different spreadsheets among the plurality of spreadsheets, and different spreadsheet components corresponding to the different spreadsheets belong to different spreadsheet component sets; the service information corresponding to the first field and the service information corresponding to the second field are service information in different service stages.

As an optional implementation of the embodiments of the present disclosure, the target event includes a recruitment event;
the service information corresponding to the first field includes any of the following information:
interview progress information and candidate information;
the service information corresponding to the second field includes any of the following information:
the interview progress information, the candidate information, degree of completion of recruitment requirements, and record information of new employees.

As an optional implementation of the embodiments of the present disclosure, the apparatus also includes:
an extraction module, used for, in response to a preset trigger, extracting target service information from a first spreadsheet, the first spreadsheet being at least one spreadsheet in the service information processing apparatus; and
a synchronization module, used for synchronizing the target service information to a target application.

As an optional implementation of the embodiments of the present disclosure, the synchronization module is specifically used for: determining a first parameter of a first type of information in the target application based on the target service information, and synchronizing the first parameter to the target application, so as to instruct the target application to display the first type of information according to the first parameter.

As an optional implementation of the embodiments of the present disclosure, the target application is a calendar application, and the synchronization module is specifically used for: based on the target service information, creating or updating a first schedule information corresponding to the target service information by means of a target calendar in the target application.

As an optional implementation of the embodiments of the present disclosure, the target calendar includes a calendar associated with the service information processing apparatus in the calendar application.

As an optional implementation of the embodiments of the present disclosure, the synchronization module is specifically used for: based on the target service information, creating or updating a first schedule information corresponding to the target service information in the target calendar;
determining participant information corresponding to the first schedule information; and
creating or updating the first schedule information in personal calendars associated with the participant information.

As an optional implementation of the embodiments of the present disclosure, the synchronization module is specifically used for: determining participant information corresponding to the target service information, the target calendar including personal calendars in the calendar application associated with the participant information; and
based on the target service information, creating or updating the first schedule information in the personal calendars.

In a third aspect, provided is an electronic device, including: a processor, a memory, and a computer program stored in the memory and runnable on the processor, when the computer program is executed by the processor, the service information processing method as claimed in the first aspect or any one of its optional implementations being implemented.

In a fourth aspect, provided is a computer-readable storage medium, including: a computer program stored on the computer-readable storage medium, when the computer program is executed by a processor, the service information processing method as claimed in the first aspect or any one of its optional implementations being implemented.

In a fifth aspect, provided is a computer program product, characterized in that when running on a computer, the computer program product causes the computer to implement the service information processing method as claimed in the first aspect or any one of its optional implementations.

### BRIEF DESCRIPTION OF THE DRAWINGS

The accompanying drawings herein, which are incorporated in and constitute a part of this specification, illustrate embodiments consistent with the present disclosure and, together with the specification, serve to explain the principles of the present disclosure.

In order to more clearly illustrate the embodiments of the present disclosure or the technical solutions in the related art, the accompanying drawings required for use in the embodiments or the description of the related art will be briefly introduced below. Obviously, for those of ordinary skill in the art, other accompanying drawings can be obtained based on these accompanying drawings without paying any creative labor.

FIG. 1 is a schematic diagram of a page of a recruitment management application provided in an embodiment of the present disclosure;

FIG. 2 is a schematic diagram of a page of a recruitment management application under the configuration of a permission provided in an embodiment of the present disclosure;

FIG. 3 is a first flow diagram of a service information processing method provided in an embodiment of the present disclosure;

FIG. 4 is a second flow diagram of a service information processing method provided in an embodiment of the present disclosure;

FIG. 5 is a third flow diagram of a service information processing method provided in an embodiment of the present disclosure;

FIG. 6 is a schematic diagram of a trigger operation on a synchronization control associated with a first record information, provided in an embodiment of the present disclosure;

FIG. 7 is a schematic diagram of creating or updating a first schedule information in a target calendar, provided in an embodiment of the present disclosure;

FIG. 8 is a structural block diagram of a service information processing apparatus provided in an embodiment of the present disclosure; and

FIG. 9 is a schematic diagram of a hardware structure of an electronic device provided in an embodiment of the present disclosure.

### DETAILED DESCRIPTION

In order to more clearly understand the above objects, features and advantages of the present disclosure, the solutions of the present disclosure will be further described below. It should be noted that, in the absence of conflict, the embodiments of the present disclosure and the features in the embodiments may be combined with each other.

In the following description, many specific details are set forth to facilitate a full understanding of the present disclosure, but the present disclosure may also be implemented in other ways different from those described herein; it is obvious that the embodiments in the specification are only part of the embodiments of the present disclosure, rather than all of the embodiments.

To deal with some complex matters, professional processing software is currently used to deal with the flows of these complex matters in a unified way, or different personnel use different files to record relevant information respectively, and then the progress of the project is promoted through offline interaction between personnel, etc. The above method of software dealing with flows in a unified way is not flexible enough, and information communication is inefficient and prone to errors when dealt with by personnel.

In order to solve the above problems, the embodiments of the present disclosure provide a service information processing method and apparatus, and an electronic device. The use of an event management application for the management of complex matters can improve the efficiency of service information processing, and also has a high degree of flexibility.

In the service information processing method provided in an embodiment of the present disclosure, an event management application is configured with a plurality of spreadsheet component sets, and each spreadsheet component set in the plurality of spreadsheet component sets is configured based on each service stage in the service flow of a target event, and is configured to do at least one of: store service information in the service flow and display; or, change the stored service information based on a configuration in the event management application in response to input from a user; wherein the method further comprises at least one of: the event management application is configured with permission information in respect of the event management application of participants in each service stage; or, the event management application is configured with linkage settings for data in a plurality of spreadsheets corresponding to a plurality of spreadsheet components in each spreadsheet component set, where the permission information and the linkage settings are determined based on the service information of a corresponding service stage. By means of this solution, event management is achieved through an online event management application. Since the event management application is configured with a plurality of spreadsheet component sets configured based on each service stage in the service flow of the target event, and these spreadsheet component sets can display and/or change the stored service information based on the configuration in the event management application in response to input from a user, it is possible to distinguish service stages to count service information, and display and/or change corresponding service information based on the input from the user. Further, since the event management application is configured with permission information in respect of the event management application of participants in each service stage, and/or with linkage settings for data in a plurality of spreadsheets corresponding to a plurality of spreadsheet components in each spreadsheet component set, different participants can manage the corresponding service information in the event management application based on the permission information, and the linkage settings for data in the plurality of spreadsheets also make it possible to automatically associate service information in each service stage, thereby improving the efficiency of service information processing when using the above event management application to manage complex matters, and also having a high degree of flexibility.

The service information processing method and apparatus, and electronic device provided in the embodiments of the present disclosure may be implemented by a service information processing apparatus or an electronic device. The service information processing apparatus may be an electronic device or a functional module or functional entity in the electronic device. The above electronic device may be a mobile phone, a tablet computer, a laptop computer, a PDA, a vehicle-mounted terminal, a wearable device, an ultra-mobile personal computer (UMPC), a netbook or a personal digital assistant (PDA), a personal computer (PC), etc., which is not specifically limited in the embodiments of the present disclosure.

In the service information processing method provided in an embodiment of the present disclosure, an event management application is configured with a plurality of spreadsheet component sets, and each spreadsheet component set in the plurality of spreadsheet component sets is configured based on each service stage in the service flow of a target event, and is configured to do at least one of: store service information in the service flow and display; or, change the stored service information based on a configuration in the event management application in response to input from a user; wherein the method further comprises at least one of: the event management application is also configured with permission information in respect of the event management application of participants in each service stage; or, the event management application is configured with linkage settings for data in a plurality of spreadsheets corresponding to a plurality of spreadsheet components in each spreadsheet component set, where the permission information and the linkage settings are determined based on the service information of a corresponding service stage.

The above each spreadsheet component set includes at least one spreadsheet component.

In some embodiments, the page of the event management application may includes a spreadsheet selection area and a spreadsheet display area, the spreadsheet selection area being used to display the spreadsheet component sets, and the spreadsheet display area being used to display a spreadsheet corresponding to a selected spreadsheet component.

The above event management application may be an application for managing any event. For example, the event management application may be a recruitment management application, a training management application, a performance management application, etc., and the above target event may be a recruitment event, a training management event, a performance management event, etc., which is not specifically limited in the embodiments of the present disclosure.

Exemplarily, taking the event management application being a recruitment management application as an example, the target event is a recruitment event, which may include: various service stages such as recruitment requirement management, recruitment position maintenance, recruitment progress management and probation period management in the recruitment event service flow.

As shown in FIG. 1, a schematic diagram of a page of a recruitment management application provided in an embodiment of the present disclosure is provided. The page of the event management application includes: a spreadsheet selection area 11 and a spreadsheet display area 12. The spreadsheet selection area 11 includes a spreadsheet component set 111 configured for recruitment position maintenance, a spreadsheet component set 112 configured for recruitment requirement management, a spreadsheet component set 113 configured for recruitment progress management, and a spreadsheet component set 114 configured for probation period management. Each spreadsheet component set may include at least one spreadsheet component, and each spreadsheet component corresponds to a spreadsheet for counting service information. By selecting a certain spreadsheet component, the spreadsheet corresponding to the spreadsheet component can be displayed in the spreadsheet display area 12. In FIG. 1, a target spreadsheet component 113a is currently selected in the spreadsheet selection area 11, and a target spreadsheet 12a corresponding to the target spreadsheet component 113a is displayed in the spreadsheet display area 12.

In some embodiments, the above permission information may include, but is not limited to, at least one of the following:

(1) An access permission to the event management application;
It may be configured that a participant is allowed to access the event management application, or may be configured that the participant is not allowed to access the event management application.

(2) A permission to display each spreadsheet component set;
After configuring the permission to display each spreadsheet component set for the participant, in the case where the participant accesses the event management application using his or her own identity information, the event management application will display, according to the permission to display each spreadsheet component set that is configured for the participant, a spreadsheet component set that is allowed to be displayed within its permission range.

(3) A permission to display each spreadsheet component in each spreadsheet component set;
After configuring the permission to display each spreadsheet component set for the participant, the permission to display each spreadsheet component in each spreadsheet component set may be further configured. In the case where the participant accesses the event management application using his or her own identity information, the event management application will display a spreadsheet component set that is allowed to be displayed within its permission range, and the spreadsheet components in the spreadsheet component set that are allowed to be displayed within its permission range.

(4) A permission to display the data in a spreadsheet corresponding to each spreadsheet component.
After configuring the permission to display each spreadsheet component set and the permission to display each spreadsheet component in each spreadsheet component set for the participant, the permission to display the data in a spreadsheet corresponding to each spreadsheet component may also be configured. In the case where the participant accesses the event management application using his or her own identity information, the event management application will display a spreadsheet component set that is allowed to be displayed within its permission range, the spreadsheet components in the spreadsheet component set that are allowed to be displayed within its permission range, and the data that are allowed to be displayed within its permission range in the spreadsheets corresponding to these spreadsheet components that are allowed to be displayed.

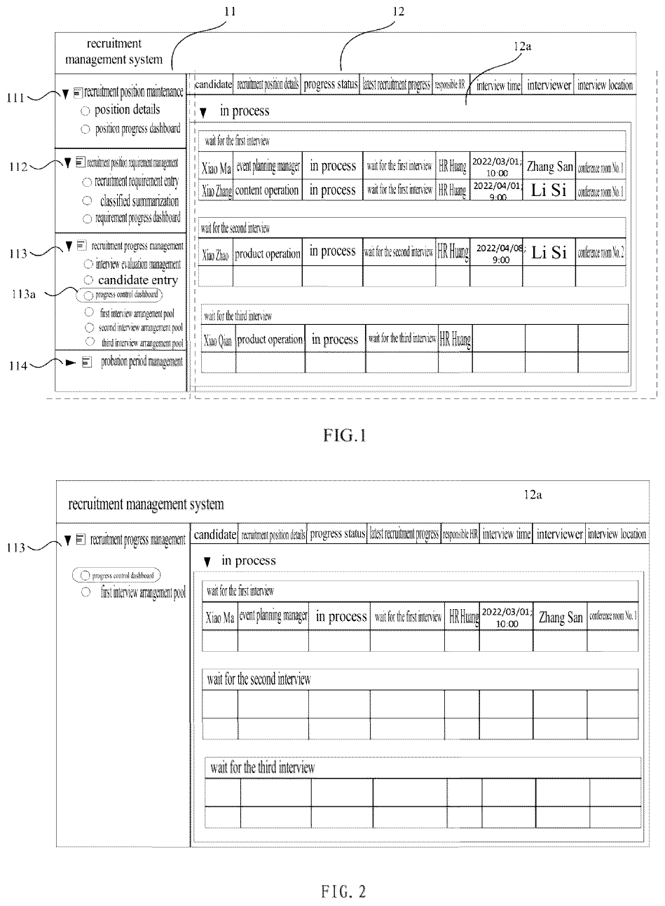

For different types of participants, their corresponding permission ranges may be different. For example, in the case where the above event management application is a recruitment management application, the permission range can be set to the maximum for the company's human resources staff (HR), allowing access to the event management application, all the spreadsheet component sets can be displayed, and each spreadsheet component in each spreadsheet component set, as well as all the data in the spreadsheet corresponding to each spreadsheet component can be displayed. As another example, for an interviewer, it may be configured that the event management application is allowed to access, and that a portion of the spreadsheet component set, spreadsheet components, and data in the spreadsheets that are required for the service stage involved in the interview is only displayed. As shown in FIG. 2, a schematic diagram of a page of a recruitment management application under the configuration of a permission provided in an embodiment of the present disclosure is provided. For an interviewer “Zhang San”, his work process only involves the spreadsheet component set 113 of the recruitment progress management configuration in FIG. 1, and only involves two spreadsheet components, namely, a “progress control dashboard” and a “one-sided arrangement pool”. For the interviewer “Zhang San”, a corresponding page of a recruitment management application may be displayed as shown in FIG. 2.

In the service information processing method provided in an embodiment of the present disclosure, an event management application is configured with a plurality of spreadsheet component sets, and each spreadsheet component set in the plurality of spreadsheet component sets is configured based on each service stage in the service flow of a target event, and is configured to do at least one of: store service information in the service flow and display; or, change the stored service information based on a configuration in the event management application in response to input from a user; wherein the method further comprises at least one of: the event management application is configured with permission information in respect of the event management application of participants in each service stage; or, the event management application is configured with linkage settings for data in a plurality of spreadsheets corresponding to a plurality of spreadsheet components in each spreadsheet component set, where the permission information and the linkage settings are determined based on the service information of a corresponding service stage. By means of this solution, event management is achieved through an online event management application. Since the event management application is configured with a plurality of spreadsheet component sets configured based on each service stage in the service flow of the target event, and these spreadsheet component sets can display and/or change the stored service information based on the configuration in the event management application in response to input from a user, it is possible to distinguish service stages to count service information, and display and/or change corresponding service information based on the input from the user. Further, since the event management application is configured with permission information in respect of the event management application of participants in each service stage, and/or with linkage settings for data in a plurality of spreadsheets corresponding to a plurality of spreadsheet components in each spreadsheet component set, different participants can manage the corresponding service information in the event management application based on the permission information, and the linkage settings for data in the plurality of spreadsheets also make it possible to automatically associate service information in each service stage, thereby improving the efficiency of service information processing when using the above event management application to manage complex matters, and also having a high degree of flexibility.

As shown in FIG. 3, a first flow diagram of a service information processing method provided in an embodiment of the present disclosure is provided. The method includes the following steps 301 to 305:

301. Configure a plurality of spreadsheet component sets of an event management application.

Each spreadsheet component set in the plurality of spreadsheet component sets is configured based on each service stage in the service flow of a target event.

302. Configure permission information in respect of the event management application of participants in each service stage in the event management application.

The permission information may include, but is not limited to, at least one of the following: (1) an access permission to the event management application, (2) a permission to display each spreadsheet component set, (3) a permission to display each spreadsheet component in each spreadsheet component set, and (4) a permission to display the data in a spreadsheet corresponding to each spreadsheet component.

When configuring the permission information in respect of the event management application of participants in each service stage in the event management application, different permission ranges can be configured for different participants.

303. Acquire identity information of a user logging into the event management application.

The identity information of the user logging into the event management application may refer to the user's login account.

Further, after acquiring the identity information of the user logging into the event management application, a permission range corresponding to the identity information may be determined according to the identity information.

304. Determine the permission range corresponding to the identity information according to the configured permission information in respect of the event management application of participants in each service stage in the event management application and the identity information.

Further, after determining the permission range corresponding to the identity information, a page of the event management application may be displayed according to the permission range corresponding to the identity information.

305. Display the page of the event management application according to the permission range corresponding to the identity information and the plurality of spreadsheet component sets of the configured event management application.

The content allowed to be displayed in the page of the event management application may be determined according to the permission range corresponding to the identity information and the plurality of spreadsheet component sets of the configured event management application, and then the page of the event management application is displayed based on the content allowed to be displayed.

In some embodiments, the page of the event management application includes: a spreadsheet selection area and a spreadsheet display area. The spreadsheet selection area includes at least one spreadsheet component set among the plurality of spreadsheet component sets, and each spreadsheet component set includes at least one spreadsheet component; the spreadsheet display area displays a target spreadsheet corresponding to a currently selected target spreadsheet component.

After at least one spreadsheet component set allowed to be displayed in the page of the event management application, at least one spreadsheet component included in each spreadsheet component set allowed to be displayed among the at least one spreadsheet component set, and the data allowed to be displayed in the spreadsheet corresponding to the at least one spreadsheet component are determined according to the permission scope corresponding to the identity information and the plurality of spreadsheet component sets of the configured event management application, the page of the event management application is displayed according to the content allowed to be displayed in the determined page of the event management application. Exemplarily, in the case where the event management application is a recruitment management application, FIG. 2 shows a schematic diagram of a page of a recruitment management application displayed after the identity information of the interviewer “Zhang San” is used to log in to the recruitment management application.

In the service information processing method provided in an embodiment of the present disclosure, since the event management application is configured with the permission information with respect of the event management application of participants in each service stage, different participants can manage the corresponding service information in the event management application according to the permission information on this basis, preventing repeated or invalid information due to confusion of service information, thereby achieving flexible management of service information of events.

In some embodiments, after executing the above step 305, in response to a first record information being entered into the target spreadsheet, a prompt message may also be output in response to a field value of a first field in the first record information being repeated with a field value of a second field in other record information, the prompt message being used to prompt that the field value of the first field is repeated with the field value of the second field.

With regard to the solution of the above embodiment, if there are repeated field values in a same spreadsheet, a prompt message will be output to prompt and confirm whether the information is repeated, so as to prevent entering repeated information in the spreadsheet and misleading the user to refer to incorrect data in the spreadsheet.

In some embodiments, after executing the above step 305, in response to the first record information being entered into the target spreadsheet, in response to the field value of the first field in the first record information being repeated with the field value of the second field in other record information, a prompt field value may also be filled in a repeat prompt field in the target spreadsheet, the prompt field value being used to prompt that the field value of the first field is repeated with the field value of the second field.

By filling the prompt field value in the repeat prompt field in the target spreadsheet to prompt that the field value of the first field is repeated with the field value of the second field, there is no need to set up pop-up modes other than the spreadsheets for prompt, so that, on the one hand, development costs can be reduced; on the other hand, compared with prompts through the pop-up mode, the prompt field value can be continuously displayed in the target spreadsheet before the user performs targeted processing, waiting for the user to confirm the service information in a repeated field value, so as to prevent the situation where the user forgets to confirm the service information in the repeated field value after a pop-up prompt, which subsequently misleads the user to refer to incorrect data in the spreadsheet.

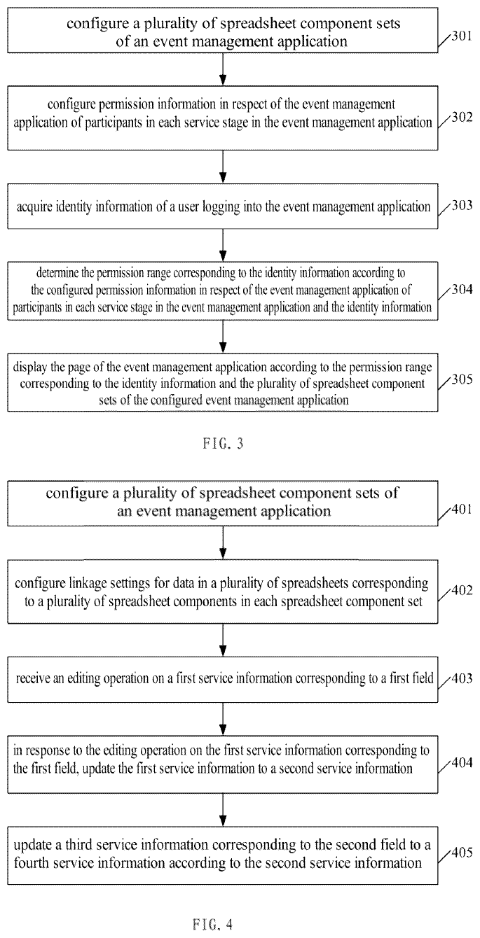

Exemplarily, as shown in FIG. 4, a second flow diagram of a service information processing method provided in an embodiment of the present disclosure is provided. The method may include the following steps 401 to 405:

401. Configure a plurality of spreadsheet component sets of an event management application.

Each spreadsheet component set in the plurality of spreadsheet component sets is configured based on each service stage in the service flow of a target event.

402. Configure linkage settings for data in a plurality of spreadsheets corresponding to a plurality of spreadsheet components in each spreadsheet component set.

Configuring the linkage settings for the data in the plurality of spreadsheets may refer to configuring linkage settings between fields in the plurality of spreadsheets, that is, if the service information corresponding to a field changes, the service information corresponding to another field associated with the field also automatically changes.

403: Receive an editing operation on a first service information corresponding to a first field.

404. In response to the editing operation on the first service information corresponding to the first field, update the first service information to a second service information.

The service information corresponding to the first field is the field value filled in the first field.

405. Update a third service information corresponding to a second field to a fourth service information according to the second service information.

The service information corresponding to the second field is the field value filled in the second field.

The first field and the second field are different fields in the above plurality of spreadsheets configured with data linkage settings.

There may be many possible cases for the above first field and second field:

In some embodiments, case 1: the first field and the second field are different fields in a same spreadsheet configured with data linkage settings.

In some embodiments, case 2: the first field and the second field are fields in different spreadsheets among the plurality of spreadsheets configured with data linkage settings, and different spreadsheet components corresponding to the different spreadsheets belong to a same spreadsheet component set; the service information corresponding to the first field and the service information corresponding to the second field are service information in a same service stage.

In some embodiments, case 3: the first field and the second field are fields in different spreadsheets among the plurality of spreadsheets, and different spreadsheet components corresponding to the different spreadsheets belong to different spreadsheet component sets; the service information corresponding to the first field and the service information corresponding to the second field are service information in different service stages.

In some embodiments, the target event includes a recruitment event; the service information corresponding to the first field may include, but is not limited to, any of the following information: interview progress information and candidate information.

The service information corresponding to the second field may include, but is not limited to, any of the following information: the interview progress information, the candidate information, degree of completion of recruitment requirements, and record information of new employees.

Exemplarily, assuming that the recruitment management application includes a candidate statistics spreadsheet and an interview progress spreadsheet, after adding candidate information to the first field in the candidate statistics spreadsheet, the candidate information can also be automatically added to the second field in the interview progress spreadsheet accordingly.

Exemplarily, after the candidate information is added to the first field in the interview progress spreadsheet, the interview progress information can also be automatically set to “wait for a first interview” in the second field in an interview arrangement spreadsheet.

Exemplarily, assuming that the recruitment management application includes a recruitment requirement statistics spreadsheet, after the number of recruitment requirements is newly entered in the first field, the degree of completion of the recruitment requirements in the second field of the recruitment requirement statistics spreadsheet can be automatically modified.

Exemplarily, assuming that the recruitment management application includes a recruitment requirement statistics spreadsheet and an interview progress spreadsheet, after the interview progress information is edited to final interview passed in the first field of the interview progress spreadsheet, the degree of completion of the recruitment requirements in the second field of the recruitment requirement statistics spreadsheet can be automatically modified.

Exemplarily, assuming that the recruitment management application includes a recruitment requirement statistics spreadsheet and a new employee record spreadsheet, after the interview progress information of a certain candidate in the first field of the interview progress spreadsheet is edited to “final interview passed”, the new employee record information in the second field in the new employee record information can be automatically updated to the candidate's “pending employment”.

In the service information processing method provided in an embodiment of the present disclosure, since the event management application is configured with linkage settings for data in a plurality of spreadsheets corresponding to a plurality of spreadsheet components in each spreadsheet component set, service information in each service stage can be automatically associated, so that flexible management of service information of events can be achieved when event management is implemented through an online event management application.

Exemplarily, as shown in FIG. 5, a third flow diagram of a service information processing method provided in an embodiment of the present disclosure is provided. The method may include the following steps 501 and 502:

501. In response to a preset trigger, extract target service information from a first spreadsheet.

The first spreadsheet is at least one spreadsheet in the event management application.

The extracting target service information from a first spreadsheet in response to a preset trigger may include: in response to the preset trigger, extracting target service information of a first event from a first record information corresponding to the preset trigger in the first spreadsheet.

The first event may be a sub-event of the target event, that is, an event of the target event in a certain service stage.

The above preset trigger may be any form of trigger, such as a voice trigger, and a trigger operation on a control in the first spreadsheet.

The control in the first spreadsheet may be a control component, or a trigger link, etc., which is not limited in the embodiments of the present disclosure. The above preset trigger may be a trigger that occurs in the event management application.

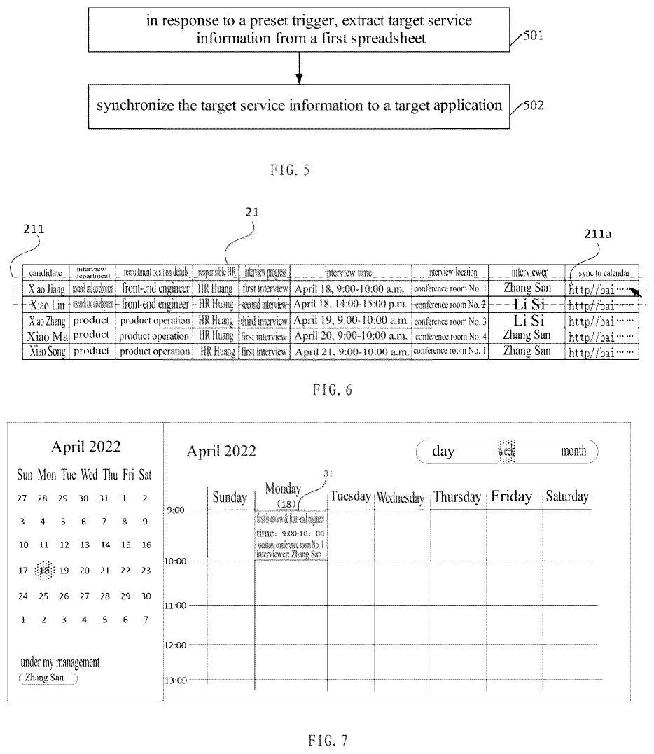

Exemplarily, as shown in FIG. 6, a schematic diagram of a trigger operation on a synchronization control associated with the first record information, provided in an embodiment of the present disclosure, is provided. The event management application being a recruitment management application is taken as an example in FIG. 6. Some record information of an interview event is recorded in a spreadsheet 21 in the recruitment management application, including the first record information 211. The first record information 211 includes a plurality of fields in the spreadsheet 21. As shown in a “sync to calendar” field 211a, the field value filled in the field is a trigger link. By clicking the trigger link, the above step 501 can be executed.

502. Synchronize the target service information to a target application.

The above target service information may include, but is not limited to, the following information:

(1) Event time information;
The event time information may include an event start time, an event end time, and event end matters, etc.
Exemplarily, as shown in FIG. 6, in the first record information 211, assuming that the first event is an interview event, specifically a first round of interviews (first interview) in the interview event, and the interview time is “9:00-10:00 a.m. on April 18th”, “9:00-10:00 a.m. on April 18th” is then the event time information of the interview event.

(2) Event location information;
In some embodiments, the event location information may include a location in an actual living space, or may include a virtual location.
Exemplarily, when the event location information is a location in an actual living space, the location may be a specific conference room, office or other place.
Exemplarily, when the event location information is a virtual location, the location may be a conference link of an online conference, or the name of a communication tool used to communicate the first event, etc.

(3) Event description information;
The event description information includes: main information describing the first event and remarks information for the first event.
The remarks information for the first event may include: information on the importance of the first event, and/or information such as precautions for the first event.
For example, for the first record information 211 shown in FIG. 6, the field “front-end engineer” in “job application details” and the interview progress “first interview” may be determined as event description information, and the event description information may be “the first interview of a front-end engineer”. The values of other fields in FIG. 6 or other information outside FIG. 6 may also be used as event description information, which is not specifically limited in the embodiment of the present disclosure.

(4) Participant information
The participant information may include at least one of the following:
Basic information such as the name of the participant, and some information of the participant associated with the first event.
For example, for an interview event, the participant information may include: candidate information and interviewer information. The candidate information may include a candidate's ID and detailed description of the candidate, and the interviewer information may include an interviewer's ID. The information can help the interviewer understand the candidate's profile and assist the interviewer in asking questions and examining the candidate during the interview.

When there is relatively more content in some participant information, the participant information may be linked by means of a hyperlink, that is, the participant information included in the target service information may be a hyperlink to the participant information. For example, information such as the candidate's resumes may be linked by means of the hyperlink.

In some embodiments, synchronizing the target service information to a target application may include: first determining a first parameter of a first type of information in the target application based on the target service information, and then synchronizing the first parameter to the target application, so as to instruct the target application to display the first type of information according to the first parameter.

The target application may include various types of information, such as chart information, schedule information, and summary information. Each type of parameters will correspond to different parameters.

Exemplarily, taking the above first type of information being schedule information as an example, the first parameter may be a relevant parameter in the schedule information, such as time, location, and participants.

In some embodiments, the target application is a calendar application, and synchronizing the target service information to the target application may be: based on the target service information, creating or updating a first schedule information corresponding to the target service information by means of a target calendar in the target application.

As shown in FIG. 7, a schematic diagram of creating or updating a first schedule information in a target calendar, provided in an embodiment of the present disclosure is provided. In response to a click operation on the trigger link in the “sync to calendar” field 211a in above FIG. 6, event parameters in the first record information 211 can be acquired, including: an interview time, an interview location and an interviewer, and the first schedule information 31 as shown in FIG. 3 is created or updated in the calendar shown in FIG. 7.

The above creation or updating of the first schedule information corresponding to the target service information by means of the target calendar in the target application based on the target service information may include, but is not limited to, the following situations when being implemented:

Case 1: in some embodiments, the target calendar includes a calendar (hereinafter referred to as an event management calendar) that is associated with the event management application in the calendar application. Based on the target service information, the first schedule information corresponding to the target service information may be created or updated in the event management calendar.

In case 1, the event management calendar is associated with the event management application, so that calendar identities (IDs) of the event management calendar associated with the event management application are saved. According to the calendar IDs, the first schedule information corresponding to the target service information may be created or updated in the event management calendar.

Case 2: in some embodiments, based on the target service information, first schedule information corresponding to the target service information is first created or updated in the event management calendar; participant information corresponding to the first schedule information is then determined; and the first schedule information is created or updated in personal calendars associated with the participant information.

In case 2, the event management calendar is associated with the event management application, so that the calendar IDs of the event management calendar associated with the event management application are saved. According to the calendar IDs, the first schedule information corresponding to the target service information may be created or updated in the event management calendar.

Further, in the case where the participant information corresponding to the first schedule information is determined, personal calendars associated with the participant information may be determined by determining the calendar IDs associated with the participant information, and the first schedule information may be created or updated in these personal calendars.

In some embodiments, acquiring personal calendars associated with the participant information may be pre-storing some correspondences between the participant information the and calendar IDs of the personal calendars, and determining the calendar IDs of the personal calendars associated with the participant information corresponding to the first schedule information by querying the pre-stored correspondences.

Case 3: in some embodiments, based on the target service information, creating or updating a first schedule information corresponding to the target service information by means of a target calendar in a target application includes:
determine participant information corresponding to the target service information, the target calendar including personal calendars in the calendar application associated with the participant information; and
based on the target service information, create or update the first schedule information in the personal calendars.

In some embodiments, acquiring personal calendars associated with the participant information may be pre-storing some correspondences between the participant information and calendar IDs of the personal calendars, and determining the calendar IDs of the personal calendars associated with the participant information corresponding to the target service information by querying the pre-stored correspondences.

In other embodiments, the above participant information may be sent to the calendar application to request the calendar application for the calendar IDs corresponding to the above participant information, thereby determining the calendar IDs of the personal calendars associated with the participant information corresponding to the target service information.

The above three situations are only exemplary descriptions, and the first schedule information may also be created or updated in the target calendar in other ways, which are not limited in the embodiments of the present disclosure. It should be noted that, in actual implementation, the above three situations usually do not occur at the same time, that is, in actual implementation, only one of the above three situations will be executed.

In the embodiments of the present disclosure, data can be automatically extracted from the event management application in a manner that an event management application manages events, and a schedule can be automatically created based on the extracted data and synchronized to the target application, which simplifies the process of summarizing information and formulating interview schedules, and improves the efficiency of event management.

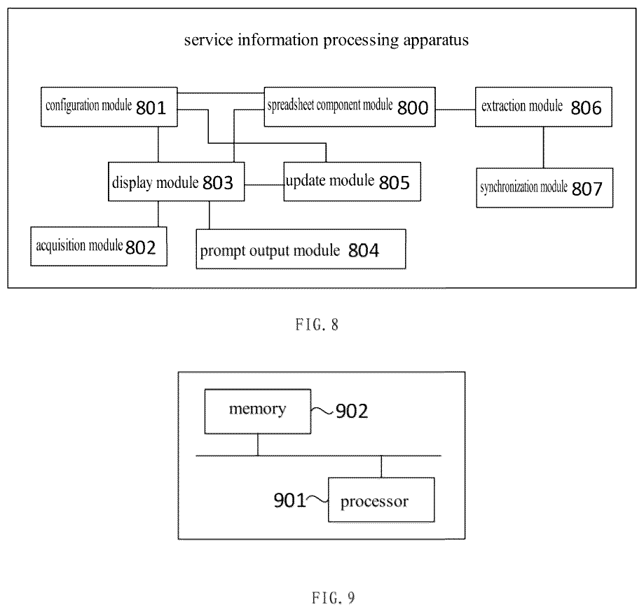

As shown in FIG. 8, a structural block diagram of a service information processing apparatus provided in an embodiment of the present disclosure is provided. The service information processing apparatus includes:
a spreadsheet component module 800, which includes a plurality of spreadsheet component sets for the service information processing apparatus, each spreadsheet component set in the plurality of spreadsheet component sets being configured based on each service stage in a service flow of a target event, and being configured to store service information in the service flow and display and/or change the stored service information based on a configuration of the service information processing apparatus in response to input from a user; and
a configuration module 801, configured to configure permission information in respect of the service information processing apparatus of participants in each service stage for the service information processing apparatus, and/or configure linkage settings for data in a plurality of spreadsheets corresponding to a plurality of spreadsheet components in each spreadsheet component set, wherein the permission information and the linkage settings are determined based on the service information of a corresponding service stage.

As an optional implementation of the embodiments of the present disclosure, the permission information includes at least one of the following:
an access permission to the service information processing apparatus;
a permission to display each spreadsheet component set;
a permission to display each spreadsheet component in each spreadsheet component set; and
a permission to display the data in a spreadsheet corresponding to each spreadsheet component.

As an optional implementation of the embodiments of the present disclosure, the apparatus also includes:
an acquisition module 802, used for acquiring identity information of a user logging into the service information processing apparatus; and
a display module 803, used for displaying a page of the service information processing apparatus according to a permission range corresponding to the identity information.

As an optional implementation of the embodiments of the present disclosure, the page of the service information processing apparatus includes: a spreadsheet selection area and a spreadsheet display area;
the spreadsheet selection area includes at least one spreadsheet component set among the plurality of spreadsheet component sets, and each spreadsheet component set includes at least one spreadsheet component; the spreadsheet display area displays a target spreadsheet corresponding to a currently selected target spreadsheet component.

As an optional implementation of the embodiments of the present disclosure, the apparatus also includes: a prompt output module 804, used for, in response to a first record information being entered into the target spreadsheet, outputting a prompt message in response to a field value of a first field in the first record information being repeated with a field value of a second field in other record information, the prompt message being used to prompt that the field value of the first field is repeated with the field value of the second field.

As an optional implementation of the embodiments of the present disclosure, the prompt output module 804 is specifically used for: in response to the field value of the first field in the first record information being repeated with the field value of the second field in other record information, filling a prompt field value in a repeat prompt field in the target spreadsheet, the prompt field value being used to prompt that the field value of the first field is repeated with the field value of the second field.

As an optional implementation of the embodiments of the present disclosure, the service information processing apparatus is configured with linkage settings for data in a plurality of spreadsheets corresponding to a plurality of spreadsheet components in each spreadsheet component set, and the apparatus also includes:
an update module 805, used for, in response to an editing operation on a first service information corresponding to a first field, updating the first service information to a second service information; and
updating a third service information corresponding to a second field to a fourth service information according to the second service information;
where the first field and the second field are different fields in the plurality of spreadsheets.

As an optional implementation of the embodiments of the present disclosure, the first field and the second field are different fields in a same spreadsheet among the plurality of spreadsheets,
alternatively,
the first field and the second field are fields in different spreadsheets among the plurality of spreadsheets, and different spreadsheet components corresponding to the different spreadsheets belong to a same spreadsheet component set; the service information corresponding to the first field and the service information corresponding to the second field are service information in a same service stage;
alternatively,
the first field and the second field are fields in different spreadsheets among the plurality of spreadsheets, and different spreadsheet components corresponding to the different spreadsheets belong to different spreadsheet component sets; the service information corresponding to the first field and the service information corresponding to the second field are service information in different service stages.

As an optional implementation of the embodiments of the present disclosure, the target event includes a recruitment event;
the service information corresponding to the first field includes any of the following information:
interview progress information and candidate information;
the service information corresponding to the second field includes any of the following information:
the interview progress information, the candidate information, degree of completion of recruitment requirements, and record information of new employees.

As an optional implementation of the embodiments of the present disclosure, the apparatus also includes:
an extraction module 806, used for, in response to a preset trigger, extracting target service information from a first spreadsheet, the first spreadsheet being at least one spreadsheet in the service information processing apparatus; and
a synchronization module 807, used for synchronizing the target service information to a target application.

As an optional implementation of the embodiments of the present disclosure, the synchronization module 807 is specifically used for: determining a first parameter of a first type of information in the target application based on the target service information, and synchronizing the first parameter to the target application, so as to instruct the target application to display the first type of information according to the first parameter.

As an optional implementation of the embodiments of the present disclosure, the target application includes a calendar application, and the synchronization module 807 is specifically used for: based on the target service information, creating or updating a first schedule information corresponding to the target service information by means of a target calendar in the target application.

As an optional implementation of the embodiments of the present disclosure, the target calendar includes a calendar associated with the service information processing apparatus in the calendar application.

As an optional implementation of the embodiments of the present disclosure, the synchronization module 807 is specifically used for: based on the target service information, creating or updating a first schedule information corresponding to the target service information in the target calendar;
determining participant information corresponding to the first schedule information; and
creating or updating the first schedule information in personal calendars associated with the participant information.

As an optional implementation of the embodiments of the present disclosure, the synchronization module 807 is specifically used for: determining participant information corresponding to the target service information, the target calendar including personal calendars in the calendar application associated with the participant information; and
based on the target service information, creating or updating the first schedule information in the personal calendars.

As shown in FIG. 9, a schematic diagram of a hardware structure of an electronic device provided in an embodiment of the present disclosure is provided. The electronic device includes: a processor 901, a memory 902, and a computer program stored in the memory 902 and runnable on the processor 901. When the computer program is executed by the processor 901, various processes of the service information processing method in the above method embodiments are implemented, and the same technical effect can be achieved, which will not be repeated here to avoid repetition.

An embodiment of the present invention provides a computer-readable storage medium, which stores a computer program. When the computer program is executed by a processor, various processes of the service information processing method in the above method embodiments are implemented, and the same technical effect can be achieved, which will not be repeated here to avoid repetition.

The computer-readable storage medium may be a read-only memory (ROM), a random access memory (RAM), a magnetic disk or an optical disk, etc.

An embodiment of the present invention provides a computer program product, which stores a computer program. When the computer program is executed by a processor, various processes of the service information processing method in the above method embodiments are implemented, and the same technical effect can be achieved, which will not be repeated here to avoid repetition.

Those skilled in the art should understand that the embodiments of the present disclosure may be provided as methods, systems, or computer program products. Accordingly, the present disclosure may take the form of an entirely hardware embodiment, an entirely software embodiment, or an embodiment combining software and hardware aspects. Furthermore, the present disclosure may take the form of a computer program product implemented on one or more computer-usable storage media containing computer-usable program code therein.

In the present disclosure, the processor may be a central processing unit (CPU), or other general-purpose processors, digital signal processors (DSP), application specific integrated circuits (ASIC), field-programmable gate arrays (FPGA) or other programmable logic devices, discrete gate or transistor logic devices, discrete hardware components, etc. A general purpose processor may be a microprocessor, or the processor may be any conventional processor, etc.

In the present disclosure, the memory may include a non-permanent memory in a computer-readable medium, in the form of a random access memory (RAM) and/or a non-volatile memory such as a read-only memory (ROM) or a flash RAM. The memory is an example of the computer-readable medium.

In the present disclosure, computer-readable media include permanent and non-permanent, removable and non-removable storage media. The storage media may implement information storage by any method or technology, and the information may be computer-readable instructions, data structures, program modules or other data. Examples of computer storage media include, but are not limited to, a phase change memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disk read-only memory (CD-ROM), a digital versatile disk (DVD) or other optical storages, a magnetic cassette, magnetic disk storage or other magnetic storage devices, or any other non-transmission media that can be used to store information that can be accessed by a computing device. According to the definition herein, computer-readable media do not include temporary computer-readable media (transitory media), such as modulated data signals and carrier waves.

It should be noted that relational terms such as “first” and “second” herein are merely used to distinguish one entity or operation from another entity or operation, and do not necessarily require or imply any actual relationship or order between these entities or operations. Furthermore, the terms “includes”, “contains”, or any other variations thereof are intended to cover non-exclusive inclusion, such that a process, method, article, or device that includes a list of elements includes not only those elements but also other elements not expressly listed, or also includes elements inherent to such process, method, article, or device. Without more constraints, an element defined by the phrase “includes a . . . ” does not exclude the existence of other identical elements in the process, method, article or device including the element.

The above are merely specific implementations of the present disclosure, which enable those skilled in the art to understand or implement the present disclosure. Various modifications to these embodiments will be readily apparent to those skilled in the art, and the generic principles defined herein may be implemented in other embodiments without departing from the spirit or scope of the disclosure. Thus, the present disclosure will not be limited to the embodiments herein but will be accorded the widest scope consistent with the principles and novel features disclosed herein.

What is claimed is:

1. A service information processing method, comprising that:
an event management application is configured with a plurality of spreadsheet component sets, and spreadsheet component sets in the plurality of spreadsheet component sets are configured based on service stages in a service flow of a target event, and are configured to do at least one of: store service information in the service flow and display; or, change the stored service information based on a configuration in the event management application in response to input from a user;
wherein the method further comprises at least one of:
the event management application is configured with permission information in respect of the event management application of participants in corresponding service stage, wherein the permission information is determined based on the service information of a corresponding service stage;
or,
the event management application is configured with linkage settings for data in a plurality of spreadsheets corresponding to a plurality of spreadsheet components in a spreadsheet component set, wherein the linkage settings is determined based on the service information of a corresponding service stage.

2. The method according to claim 1, wherein the permission information comprises at least one of the following:
an access permission to the event management application;
a permission to display a spreadsheet component set;
a permission to display a spreadsheet component in a spreadsheet component set; and
a permission to display the data in a spreadsheet corresponding to a spreadsheet component.

3. The method according to claim 2, wherein the method further comprises:
acquiring identity information of the user logging into the event management application; and
displaying a page of the event management application according to a permission range corresponding to the identity information.

4. The method according to claim 1, wherein the page of the event management application comprises: a spreadsheet selection area and a spreadsheet display area;
the spreadsheet selection area comprises at least one spreadsheet component set among the plurality of spreadsheet component sets, and the spreadsheet component set comprises at least one spreadsheet component; the spreadsheet display area displays a target spreadsheet corresponding to a currently selected target spreadsheet component.

5. The method according to claim 1, wherein the method further comprises:
in response to a first record information being entered into the target spreadsheet, outputting a prompt message in response to a field value of a first field in the first record information being repeated with a field value of a second field in other record information, the prompt message being configured to prompt that the field value of the first field is repeated with the field value of the second field.

6. The method according to claim 5, wherein the outputting a prompt message in response to a field value of a first field in the first record information being repeated with a field value of a second field in other record information comprises:
in response to the field value of the first field in the first record information being repeated with the field value of the second field in other record information, filling a prompt field value in a repeat prompt field in the target spreadsheet, the prompt field value being configured to prompt that the field value of the first field is repeated with the field value of the second field.

7. The method according to claim 1, wherein the event management application is configured with linkage settings for data in a plurality of spreadsheets corresponding to a plurality of spreadsheet components in a spreadsheet component set, and the method further comprises:
in response to an editing operation on a first service information corresponding to a first field, updating the first service information to a second service information; and
updating a third service information corresponding to a second field to a fourth service information according to the second service information;
wherein the first field and the second field are different fields in the plurality of spreadsheets.

8. The method according to claim 7, wherein
the first field and the second field are different fields in a same spreadsheet among the plurality of spreadsheets, or the first field and the second field are fields in different spreadsheets among the plurality of spreadsheets, and different spreadsheet components corresponding to the different spreadsheets belong to a same spreadsheet component set; the service information corresponding to the first field and the service information corresponding to the second field are service information in a same service stage; or
the first field and the second field are fields in different spreadsheets among the plurality of spreadsheets, and different spreadsheet components corresponding to the different spreadsheets belong to different spreadsheet component sets; the service information corresponding to the first field and the service information corresponding to the second field are service information in different service stages.

9. The method according to claim 8, wherein the target event comprises a recruitment event;
the service information corresponding to the first field comprises at least one of the following information:
interview progress information; or candidate information;
the service information corresponding to the second field comprises at least one of the following information:
the interview progress information; or, the candidate information; or, degree of completion of recruitment requirements; or, record information of new employees.

10. The method according to claim 1, wherein the method further comprises:
in response to a preset trigger, extracting target service information from a first spreadsheet, the first spreadsheet being at least one spreadsheet in the event management application; and
synchronizing the target service information to a target application.

11. The method according to claim 10, wherein the synchronizing the target service information to a target application comprises:
determining a first parameter of a first type of information in the target application based on the target service information, and synchronizing the first parameter to the target application, so as to instruct the target application to display the first type of information according to the first parameter.

12. The method according to claim 10, wherein the target application is a calendar application, and the synchronizing the target service information to a target application comprises:
based on the target service information, creating or updating a first schedule information corresponding to the target service information by means of a target calendar in the target application.

13. The method according to claim 12, wherein the target calendar comprises a calendar associated with the event management application in the calendar application.

14. The method according to claim 13, wherein the based on the target service information, creating or updating a first schedule information corresponding to the target service information by means of a target calendar in the target application comprises:
based on the target service information, creating or updating a first schedule information corresponding to the target service information in the target calendar;
determining participant information corresponding to the first schedule information; and
creating or updating the first schedule information in personal calendars associated with the participant information.

15. The method according to claim 12, wherein the based on the target service information, creating or updating a first schedule information corresponding to the target service information by means of a target calendar in the target application comprises:
determining participant information corresponding to the target service information, the target calendar comprising personal calendars in the calendar application associated with the participant information; and
based on the target service information, creating or updating the first schedule information in the personal calendars.

16. An electronic device, comprising: a processor, a memory, and a computer program stored in the memory and runnable on the processor, when the computer program is executed by the processor, the following operations are implemented:
an event management application is configured with a plurality of spreadsheet component sets, and spreadsheet component sets in the plurality of spreadsheet component sets are configured based on service stages in a service flow of a target event, and are configured to do at least one of: store service information in the service flow and display; or, change the stored service information based on a configuration in the event management application in response to input from a user;
wherein the electronic device further comprises at least one of:
the event management application is configured with permission information in respect of the event management application of participants in corresponding service stage, wherein the permission information is determined based on the service information of a corresponding service stage;
or,
the event management application is configured with linkage settings for data in a plurality of spreadsheets corresponding to a plurality of spreadsheet components in a spreadsheet component set, wherein the linkage settings is determined based on the service information of a corresponding service stage.

17. A non-transitory computer-readable storage medium, comprising: a computer program stored on the computer-readable storage medium, when the computer program is executed by a processor, the following operations are implemented:
an event management application is configured with a plurality of spreadsheet component sets, and spreadsheet component sets in the plurality of spreadsheet component sets is configured based on service stages in a service flow of a target event, and are configured to do at least one of: store service information in the service flow and display; or, change the stored service information based on a configuration in the event management application in response to input from a user;
wherein the non-transitory computer-readable storage medium further comprises at least one of:
the event management application is configured with permission information in respect of the event management application of participants in corresponding service stage, wherein the permission information is determined based on the service information of a corresponding service stage;
or,
the event management application is configured with linkage settings for data in a plurality of spreadsheets corresponding to a plurality of spreadsheet components in a spreadsheet component set, wherein the linkage settings is determined based on the service information of a corresponding service stage.

18. The electronic device according to claim 16, wherein the permission information comprises at least one of the following:
an access permission to the event management application;
a permission to display a spreadsheet component set;
a permission to display a spreadsheet component in a spreadsheet component set; and
a permission to display the data in a spreadsheet corresponding to a spreadsheet component.

19. The electronic device according to claim 18, wherein when the computer program is executed by the processor, the following operations are further implemented:
acquiring identity information of the user logging into the event management application; and
displaying a page of the event management application according to a permission range corresponding to the identity information.

20. The non-transitory computer-readable storage medium according to claim 17, wherein the permission information comprises at least one of the following:
an access permission to the event management application;
a permission to display a spreadsheet component set;
a permission to display a spreadsheet component in a spreadsheet component set; and
a permission to display the data in a spreadsheet corresponding to a spreadsheet component.
